(19) United States
(12) Patent Application Publication
(10) Pub. No.: US 2007/0246033 A1
(43) Pub. Date: Oct. 25, 2007

(54) System to Convey Air for Convection or Static Ovens Through Cylinders and/or Interstice and System of Vertical Opposed Ventilation

(76) Inventor: Gilberto Cattaneo, Formigine (IT)

Correspondence Address: Modiano & Associati, Via Meravigli, 16, 20123 Milano, IT

(21) Appl. No.: 11/579,147

(22) PCT Filed: May 13, 2005
(86) PCT No.: PCT/IB05/01319

§ 371 Date: Oct. 30, 2006

(30) Foreign Application Priority Data
May 14, 2004 (IT) MO2004A000114

(51) Int. Cl. A21B 1/26

(52) U.S. Cl. 126/15 A

(57) ABSTRACT

The invention is in the field of devices for heating and/or cooking food and consists in inserting, in conventional static convection ovens, two ventilation elements, which are vertically mutually opposite and concentric with respect to two resistors, respectively, and can be contained in two movable tubular bodies; respectively, the lower body is anchored to the bottom of the oven and the upper body is anchored to the top of the oven. The tubular bodies, depending on their diameter, can contain a diaphragm, which is provided with a plurality of holes, or a housing, which is also provided with holes.

### TECHNICAL FIELD

The present invention relates to a device that heats and/or cooks food placed at the center of two forced and opposite hot air streams.

### BACKGROUND ART

Forced convection ovens have been used for some time particularly in the field of public and community catering to heat and/or cook bakery food, constituted in particular by products such as bread, pasta, pizza and focaccia.

Known embodiments of this type of oven can be of two types: a first type, termed static, in which the food to be processed is introduced in the oven on supports or rests on the bottom, and a second type, termed non-static, in which the food to be processed passes through two streams of air and is conveyed by a belt.

Known static ovens have some common characteristics, the most important of which are constituted by the presence of one or more ventilation elements for forming the stream of heating air, by the fact that said streams are horizontal with respect to the food to be processed, and by the presence of a perforated diaphragm that is suitable to adjust said stream, said diaphragm being shaped so as to have two sides thereof that adhere to the internal body of the oven.

As regards non-static ovens, an embodiment is known in which the food to be processed is placed on a conveyor belt that is intended to pass through the stream of heating air that arrives from above and from below and is aspirated laterally or vertically.

These known types of embodiment have drawbacks.

The presence of ventilating elements that have a horizontal stream causes, when the door is opened, a massive outflow of heat, with a corresponding reduction of the temperature inside the chamber, compromising the result of subsequent bakings.

The known shapes of said diaphragm for adjusting the stream of heating air propel said air only along two sides of the internal perimeter of the oven and accordingly this fact, too, limits the uniform heating and/or cooking of the food.

### SUMMARY OF THE INVENTION

The aim of the present invention is to provide an oven that is suitable to heat and cook uniformly the food placed in the middle of the stream of forced air generated by the ventilating elements.

In particular, the device for heating and/or cooking food according to the present invention, of the static type, which utilizes the principle of forced convection and is provided with heating elements that are concentric with respect to the ventilating elements, comprises:
two ventilating elements with concentric resistors, which are superimposed, mutually opposite and substantially centered with respect to a central vertical axis of the device; each one of said elements is provided with its own motor means.

The device can further comprise two diaphragms for adjusting the stream of heated air, each of which is coaxial with respect to the central vertical axis of the device, each one of said diaphragms being located at each one of the two internal bodies, or, in an alternative and equivalent embodiment, two protective housings instead of said internal bodies and said diaphragms; two elements with vanes connected by a shaft to each motor means;

said motor means being provided optionally with a second motor shaft with elements provided with vanes that are designed to cool the respective motor means.

### BRIEF DESCRIPTION OF THE DRAWINGS

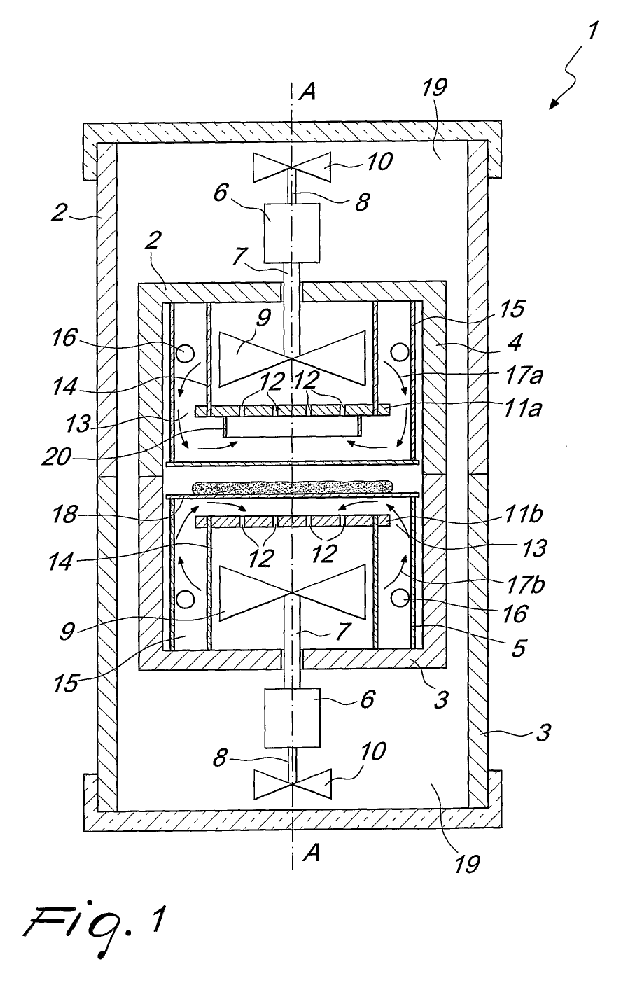

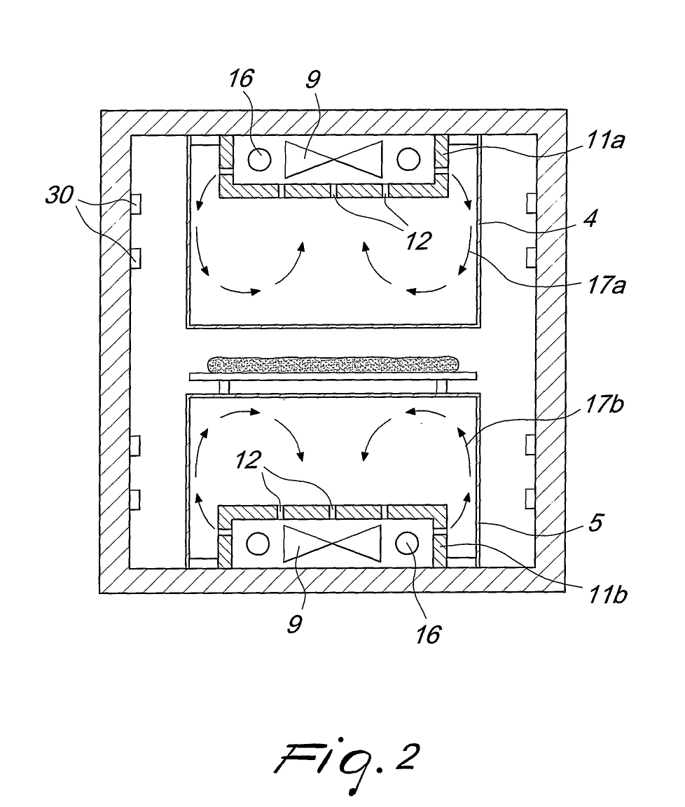

Further characteristics and advantages of the invention will become better apparent from the following description of two embodiments thereof, illustrated merely by way of non-limiting example in the accompanying drawing,

wherein FIGS. 1 and 2 are schematic sectional views respectively of a first embodiment of the invention and of a second alternative and equivalent embodiment of the invention.

### WAYS OF CARRYING OUT THE INVENTION

With reference to FIG. 1, which illustrates a first embodiment of the invention, the reference numeral 1 designates an external body of a common static oven, the reference numeral 2 designates internal walls, and the reference numeral 3 designates a door of the oven, which is not shown.

Inside said device there can be a first movable tubular internal body 4, which can be anchored to the ceiling of the oven, and a second tubular internal body 5, which can be anchored to the bottom of the oven.

A motor means 6 is rigidly coupled to each one of said two internal bodies, on their outer surface, and so that they are aligned with a central vertical axis A-A of the device 1.

Each one of said motor means is provided with a first motor shaft 7 and with a second motor shaft 8; the two motor shafts 8 are mutually opposite and directed toward the inside of the device 1, and a ventilation element 9 is rigidly coupled to each shaft, while the two motor shafts 8 are directed toward the outside of said device and an element with vanes 10 is rigidly coupled to each one of said shafts. The first motor shafts 7 and the second motor shafts 8 are aligned along the axis A-A.

A diaphragm 11a can be inserted, if necessary, in the first internal body 4, and a diaphragm 11b can be inserted in the second internal body 5; both of said diaphragms are circular and are provided with a plurality of holes 12 that pass through the thickness of said diaphragms; said diaphragms are centered with respect to the axis A-A and have an outside diameter that is smaller than the inside diameter of the respective internal bodies, thus providing a circumferential empty space 13, which completely separates, without discontinuities, said diaphragms from the respective internal bodies.

The reference numeral 14 designates supports for the diaphragms 11a and 11b.

The reference numeral 15 designates the internal portion of the first and second internal bodies 4 and 5; a heating element 16, particularly an electric resistor connected to a thermostat that is not shown, is arranged in each one of said internal portions.

According to an alternative embodiment that is equivalent to what has been described so far, FIG. 2 shows how the heating element 16 and the ventilation element 9 can be contained in a perforated protective housing, which equivalently replaces the function of the diaphragms 11a and 11b described in the first embodiment.

The use of the protective housing instead of the diaphragms allows to have smaller dimensions of the assembly constituted by said housing, by the ventilating element 9 and by the heating element 16.

The housing further has a protective function that the diaphragm does not have. The cross-section of FIG. 2 in fact shows that the heating elements 16 in this case are arranged inside said housing, which accordingly also assumes a protective function for said elements.

The reference numeral 17a designates, in both FIGS. 1 and 2, the path of the heated air inside the first internal body 4, and the reference numeral 17b designates the path of the heated air inside the second internal body 5; the reference numeral 18 designates the support of the product to be heated and/or cooked.

A chamber 19 is provided inside the internal wall 2 and inside the door 3 and accommodates the motor means 6.

In the embodiment shown in FIG. 1, the reference numeral 20 designates a tubular element that can be fixed to the surfaces of the diaphragms 11a and 11b that face each other; the application of said tubular element is optional and can affect even just one of said two diaphragms, as indeed shown in the figure.

The operation of the device according to the present invention is now described with reference to FIGS. 1 and 2.

After placing the food to be heated and/or cooked on the support 18, resting it on the tubular body 5, the door of the oven 3, not shown, is closed.

After activating the heating elements 16 and both the motor means 6, the air is contained by the walls of the bodies 4 and 5 and is propelled forcibly directly onto the product or is drawn through the holes 12 and reaches the chambers 19, where it is heated as a consequence of the heat radiated by said heating elements; propelled by the action of the ventilating elements 9, at the first internal body 4 the heated air descends below the diaphragm or housing, following the path 17a, while at the second internal body 5 the heated air rises above the diaphragm 11b or the housing, following the path 17b.

Since in the case of the first embodiment shown in FIG. 1 there is the empty space 13 between the internal surface of said internal bodies and the external lateral dimensions of said diaphragms, the heated air that follows the paths 17a and 17b is distributed uniformly on all the exposed parts of the food to be heated and/or cooked, with the possibility to adjust the upper and lower temperatures; this adjustment possibility can be obtained by means of temperature regulators.

In the case of the alternative and equivalent embodiment shown in FIG. 2, the same uniform distribution of heated air along the illustrated lines of flow, designated by the same reference numerals used in FIG. 1, is obtained in this case by providing a similar empty space 13 between each housing and the corresponding internal body 4 and 5.

The first embodiment of FIG. 1 shows that in order to adjust in various manners the inflow of heating air it is possible to use a tubular element 20, by means of which, by adjusting in various manners the stream of heating air, it is possible to heat to a greater extent the lateral parts of the food being heated and/or cooked and to a lesser extent the internal parts thereof; said adjustment of the air stream can be obtained by using, according to requirements, tubular elements that have different lengths.

The main advantage of the device according to the present invention is constituted by the uniform heating and cooking of the food placed in the middle of the forced ventilation, both with the bodies 4 and 5 and without them.

The present invention can also be used as a conventional oven by extracting the two cylindrical bodies 4 and 5, thus providing only for the presence of the two housings 11a and 11b described in the embodiment of FIG. 2 instead of said cylindrical bodies, so that the oven is suitable to cook products rested on grills or the like, which can be inserted slidingly along substantially horizontal conventional guides 30 provided along the side walls of said oven.

In the description, explicit reference has been made to bakery products, but it is evident that the present invention is advantageously suitable for both heating and cooking foods of a different type, such as for example meat, fish, vegetables, etc.

The description has also referenced the use of the present invention in the field of public and community catering, but it is evident that the invention can be used advantageously also in a domestic environment.

The disclosures of Italian patent application No. MO2004A000114, from which this patent claims priority, is included by reference.

What is claimed is:

1-10. (canceled)

11. A device for heating and/or cooking food, which is of the static type and utilizes the principle of forced convection and comprises heating elements, comprising:
two removable bodies, which can be anchored to a bottom and ceiling of an oven;
two ventilating elements, which are mutually superimposed and substantially centered with respect to a central vertical axis of the device;
each one of said ventilating elements being accommodated in an internal body, respectively a first body and a second body, and being provided with its own motor means and with at least one resistor.

12. The device of claim 11, wherein one of said removable bodies is provided with a front opening that is adapted to accommodate a support for a product to be cooked, said support being rested on the other one of said removable bodies.

13. The device of claim 11, further comprising two diaphragms for adjusting a stream of heated air, each diaphragm being coaxial with respect to the central vertical axis of the device and at each one of the two internal bodies.

14. The device of claim 13, further comprising two elements with vanes, one for each one of said motor means, which are rigidly coupled thereto by a second motor shaft, said second motor shaft protruding with respect to the motor means on an opposite side with respect to the corresponding ventilation element; said elements with vanes being designed to cool the respective motor means.

15. The device of claim 14, wherein said elements with vanes are constituted by fans.

16. The device of claim 11, further comprising two perforated protective housings, one of which is anchored to the bottom of the oven, the other one being anchored to the ceiling of the oven, each housing being adapted to enclose and protect said ventilating elements and said heating elements.

17. The device of claim 11, wherein by removing said removable bodies, the oven is adapted to cook products that rest on grills or similar supports that can be inserted and can slide in horizontal guides provided on side walls of the oven.

18. The device of claim 11, wherein the heated air is drawn along a direction that is parallel to the direction of the central vertical axis of said device; in the first internal optional body, the direction of the suction is upward and in the second optional internal body it is downward.

19. The device of claim 13, wherein each one of said diaphragms is substantially centered with respect to the vertical axis of the device, each one of said diaphragms further having a maximum external width that is smaller than a minimum internal width of said internal bodies, so that an empty space separates completely, without discontinuities, said diaphragms from the respective internal body.

20. The device of claim 11, further comprising at least one tubular element, which is applied to at least one of the surfaces of said diaphragms that face each other.
